(19) United States
(12) Patent Application Publication
(10) Pub. No.: US 2003/0035014 A1
(43) Pub. Date: Feb. 20, 2003

(54) Method and apparatus for reverse printing labels

(76) Inventors: Matthew Thomas Adams, Mason, OH (US); Angela Carol Thomas, Hamilton, OH (US)

Correspondence Address: ORUM & ROTH, 53 W. JACKSON BLVD, CHICAGO, IL, 60604, US

(21) Appl. No.: 10/194,333

(22) Filed: Jul. 12, 2002

Related U.S. Application Data
(60) Provisional application No. 60/305,037, filed on Jul. 12, 2001.

(51) Int. Cl. G01D 9/00

(52) U.S. Cl. 346/135.1

(57) ABSTRACT

A reverse printed label printed using ink jet or other relatively non-durable printing technology. Indicia is printed to the backside of a transparent material upon a coating of adhesive used to adhere the finished label to an object or surface. When applied to an object or surface, the finished label is readable through the transparent surface which acts as an overlaminate.

Indicia may be printed with infrared readable ink on the backside of opaque material upon a coating of adhesive used to adhere the finished label to an object or surface.

This application claims the benefit of U.S. provisional application No. 60/305037 filed Jul. 12, 2001.

### FIELD OF THE INVENTION

The invention generally relates to reverse printed labels. Specifically, the invention relates to reverse printed labels printed on an adhesive layer adhered to the bottom side of a transparent carrier material.

### DESCRIPTION OF RELATED ART

Previously, ink jet and other relatively non-durable printing technologies have had limited success in the field of labels. Ink jet inks generally do not stand up to chemicals and/or abrasive handling. For example, ink jet inks affected by chemicals or abrasion may bleed, smear, change color, or disappear altogether. Limited durability characteristics have limited acceptance of ink jet printing in label applications except for those applications where chemical contact or abrasive handling is not present or is expected to be minimal. One previous solution was to cover the finished ink jet printed labels with a separate overlaminate. Use of an overlaminate provides a protected ink surface, but adds the extra cost of the overlabel including materials, mechanical apparatus and/or application time losses.

Ink jet printing is otherwise advantageous as ink jet printing systems allow on-demand multi-color printing with ease of ink supply via quickly, replaceable, self-contained cartridges.

An object of this invention is to provide the benefits of ink jet and other relatively non-durable printing technologies on labels having increased chemical and/or abrasion resistance.

### SUMMARY OF THE INVENTION

A reverse printed label printed using non-durable printing technology, such as an ink jet printer. The ink jet printed indicia is applied to the back side of a transparent material upon a coating of adhesive used to adhere the finished label to an object or surface. When applied to an object or surface, a finished label is readable through the transparent surface which acts as an overlaminate without the added cost or mechanical steps required to apply a separate overlaminate layer.

### BRIEF DESCRIPTION OF DRAWINGS

FIG. 1 is schematic side view of a reverse printed label according to the present invention.

FIG. 2 is a flow diagram demonstrating the printing process according to the present invention.

### DETAILED DESCRIPTION

Reverse printing is a technique where printed indicia is applied to a substrate on one side in a manner where the indicia is viewable through the substrate from the other, non-printed side, oriented in reverse for correct viewing through the substrate. One example of a reverse printing capable printer protocol is third generation Intermec Programming Language (IPL3).

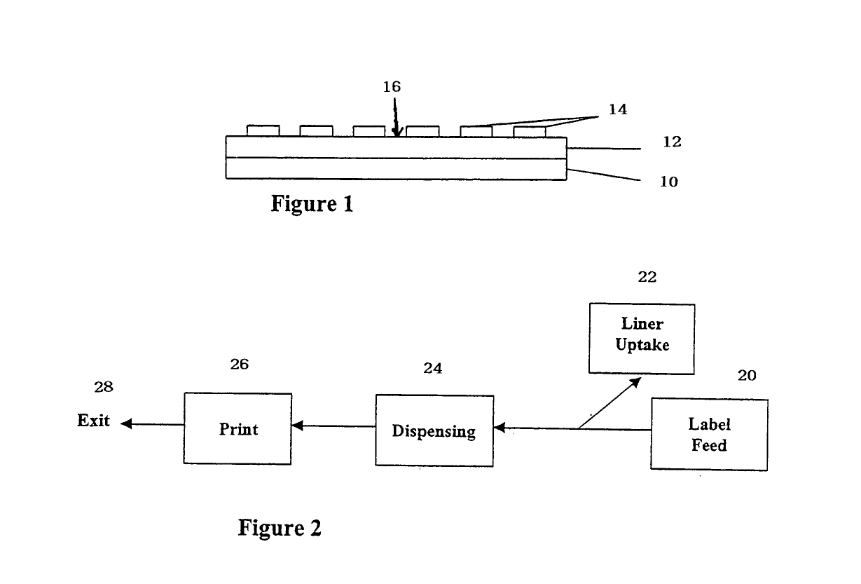

Referring to FIG. 1, a reverse printed label is shown. The unprinted label consists of at least two layers. A face material layer 10 and an adhesive layer 12. Preferably, the face material 10 is transparent. However, the face sheet may be opaque. Coating one surface of the face material 10 is an adhesive layer 12. Ink jet indicia 14 is printed to the back side of a face material 10 coated with an adhesive layer 12. When applied to a target surface (not shown) the indicia 14 is readable through the face material 10.

Indicia 14 is applied through a reverse printing protocol, deposited upon the adhesive layer 12. Indicia 14 can be any combination of text, graphics and background in any color or color combination. All of the advanced color and graphical printing abilities of ink jet printing technology may be used with reverse printing technique. One advantage of color ink jet printing, for example, is the ability to produce a label of any text, graphics or background in any color, or color combination, for example, red, green and/or yellow without requiring a media change.

The adhesive surface 16 not printed upon holds the label in place on the target surface. Care should be taken to leave enough of adhesive layer 10 uncovered by the indicia so as to allow enough adhesive surface 16 for the desired adhesion strength of the finished label to the intended surface and/or object. One method of ensuring that enough adhesive surface 16 will remain is to instruct the printer to leave an unprinted border (not shown) around the label. Alternatively, the indicia 14 may be applied in a screened pattern, again leaving enough area through the screen for the adhesive to make suitable adhesive contact with the target substrate, object and/or surface (not shown).

Referring to FIG. 2, a flow diagram demonstrating the printing process is shown. In an on-demand embodiment, as shown in FIG. 2, the printer may be configured to start with a label feed module 20 from which a liner, if present, is removed liner uptake module 22. Whereupon the linerless label is fed via a dispensing module 24 past the print heads of printer 26 with the finished printed label exiting 28 the printer 26 ready for immediate application. The printer 26 prints indicia upon the adhesive surface of label. In a case of bulk printing or where application of the finished label is not immediate, a liner may be applied to the adhesive surface of printed label. The liner, or if a liner is not present, the unprinted outer surface of the face material, may have a release coating/surface so as not to disturb the printed indicia or foul the top surface of the already printed labels as they are wound into a finished printed label roll.

Labels produced by the present invention may be used in any environment, for example, in automobile engine compartments or upon automobile windshields. The level of chemical and/or abrasion resistance of the finished label is dependent upon selection of the face material 10 and/or adhesive 12.

In a further embodiment, the face material 10 may be opaque and the ink used readable, for example, via infrared thereby creating a label with security or authentication applications.

Any printing technology, for example ink jet, bubble jet, laser, thermal or impact, capable of printing upon an adhesive layer may be used. The durability of the resulting label is not dependent upon the printed indicia's 14 characteristics, as it is protected by the face material 10 when adhered to a target surface.

Through application of, for example, ink jet printing technology the user is supplied with an on demand printing capability to produce a chemically resistant and/or durable label. A full range of colored labels may be produced from a single printer and/or print media, thereby decreasing media, inventory and production costs.

We claim:

1. A method for reverse printing a label, comprising the steps of:
a) Obtaining a label with at least two layers, wherein the first layer is a face material and the second layer is an adhesive surface; and
b) Printing indicia in reverse on an exposed surface of said adhesive.

2. The method of claim 1 further comprising the step of removing a liner from said adhesive surface before printing.

3. The method of claim 1 further comprising the step of applying a liner to said adhesive surface after printing.

4. The method of claim 1, wherein said face material is coated with a release agent.

5. The method of claim 1 further comprising the step of leaving an unprinted boarder of adhesive around said printed indicia.

6. The method of claim 1, wherein said indicia is printed in a screened pattern.

7. The method of claim 1, wherein said face material is transparent.

8. The method of claim 1 wherein said face material is opaque and the label is printed using ink readable by infrared detectors.

9. A label printed according to the method of claim 1.

10. A label, comprising:
a layered construction of
a first layer of face material and
a second layer of an adhesive, wherein
indicia is printed in reverse on an exposed surface of said adhesive.

11. The label of claim 11, wherein said indicia is in a screen pattern and adhesive is exposed through said screen.

12. The label of claim 11, wherein there is an unprinted adhesive border around said printed indicia.

13. The label of claim 11, wherein said face material is transparent.

14. The label of claim 11, wherein said face material is opaque and said indicia is printed with ink readable by infrared detectors.
